(19) United States
(12) Patent Application Publication
(10) Pub. No.: US 2026/0329775 A1
(43) Pub. Date: Oct. 22, 2026

(54) ASSIGNMENT OF A VIRTUAL FUNCTION TO A PROCESS

(71) Applicant: Intel Corporation, Santa Clara, CA (US)

(72) Inventor: Min ZHANG, Shanghai (CN)

(21) Appl. No.: 19/374,879

(22) Filed: Oct. 30, 2025

(30) Foreign Application Priority Data
Oct. 10, 2025 (WO) PCT/CN2025/126616

(51) Int. Cl. G06F 12/0868; G06F 9/455

(52) U.S. Cl. CPC G06F 12/0868; G06F 9/455; G06F 2009/45583; G06F 2212/1024

(57) ABSTRACT

Examples described herein relate to assigning a virtual function (VF) to a processor based at least, in part, on a latency of a memory write operation. In some examples, the virtual function is to provide a process with access to a device and wherein the processor is to execute the process. In some examples, the latency is associated with a VF memory address mapped to a cache and home agent (CHA).

### RELATED APPLICATION

This application claims the benefit of priority to PCT/CN2025/126616, filed Oct. 10, 2025. The entire contents of that application are incorporated by reference.

### BACKGROUND

A Single Root I/O Virtualization (SR-IOV), Peripheral Component Interconnect Express (PCIe) virtual function (VF) is a virtualized instance of a physical PCIe device that allows a hardware device to be accessible as multiple virtual devices. VFs are created by a Physical Function (PF). A VF has its own PCIe configuration space but shares physical resources such as memory and network ports with the PF and other VFs. SR-IOV enables direct, high-speed data transfers between virtual machines (VMs) and the hardware.

Intel® Scalable I/O Virtualization (SIOV) permits configuration of a device to group its resources into multiple isolated Assignable Device Interfaces (ADIs). Unlike the device partitioning approach of SR-IOV to create multiple virtual functions (VFs) on a physical function (PF), SIOV enables software to flexibly compose virtual devices utilizing the hardware-assists for device sharing at finer granularity.

### BRIEF DESCRIPTION OF THE DRAWINGS

FIG. 1 shows an example of compute dies.

FIG. 2 shows an example system.

FIG. 3 shows an example of assignment of a virtual function to a process.

FIG. 4 shows an example association of virtual function and process.

FIG. 5 shows an example of assignment of a virtual function to a process.

FIG. 6 shows an example association of virtual function and process.

FIG. 7 depicts an example process.

FIG. 8 depicts a system.

### DETAILED DESCRIPTION

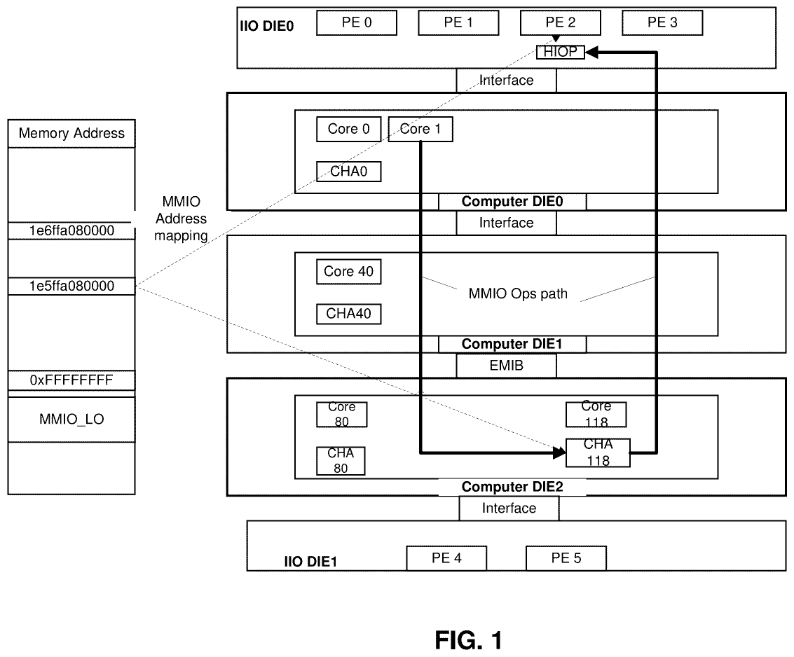

FIG. 1 shows an example of mapping a caching and home agent (CHA) to a memory mapped IO (MMIO) memory address. A network interface device PCIe Base Address Register (BAR) allows the network interface device to request and map a region of the computer's memory or input output (I/O) address space. A host (not shown) that boots a Basic Input/Output System (BIOS) assigns BAR space (including the doorbell addresses) to a VF and the BAR space address is not changed at runtime. For a VF, the MMIO address mapping to CHA118 can be performed by a calculation (e.g., hash or other calculation). However, if the MMIO address is mapped to the CHA of compute DIE2 (e.g. CHA118) instead of CHA0 on DIE0, when the MMIO request is sent from core 1, the MMIO request originates from computer DIE0 and travels through computer DIE1 to computer DIE2. A distance traveled by the MMIO request to CHA118 is longer than a distance traveled to CHA0.

A die can include with an integrated circuit, cut from a larger silicon wafer. A die can include one or more of: a processor, memory, interconnect, device interface, and other circuitry. Communications between devices can take place using a network that provides die-to-die communications; chip-to-chip communications; circuit board-to-circuit board communications; and/or package-to-package communications. A die-to-die communications can utilize Embedded Multi-Die Interconnect Bridge (EMIB) or an interposer.

At least to attempt to manage differences in latency among different virtual functions, various examples assign a virtual function (e.g., VF, ADI, or other) to a process based on latency associated with the virtual function and priority level of the process. The latency can be based on a physical signal path distance between a processor that executes a process, to the CHA, and to the VF attached to a device. However, other manners of determining latency can be utilized. A hypervisor can maintain groups of one or more virtual functions based on latency of the virtual functions and the hypervisor can assign a virtual function from a group to a process. In some cases, a group can be mapped to a computer die and assigned to a group identifier as latency can be based on a number of compute dies that a message from a process traverses to reach a CHA.

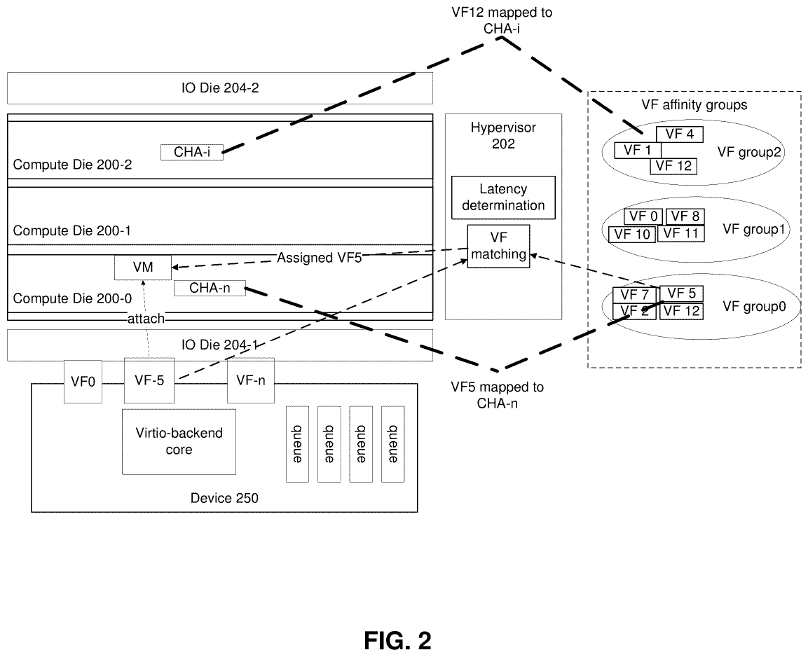

FIG. 2 shows an example system. Device 250 can include one or more of: a network interface device (e.g., Infrastructure Processing Unit (IPU) or data processing unit (DPU)), accelerator, graphics processing unit, storage device, or other devices). For example, device 250 can be accessible using one or more SR-IOV virtual functions (VFs), Intel® Scalable I/O Virtualization (SIOV) Assignable Device Interfaces (ADIs), or others. An example technical specification for SR-IOV includes Single Root I/O Virtualization (SR-IOV) and Sharing specification, version 1.1, published Jan. 20, 2010, as well as earlier versions, later versions, and variations thereof. An example technical specification for SIOV is Intel® Scalable I/O Virtualization Technical Specification, revision 1.0, June 2018, as well as earlier versions, later versions, and variations thereof. Moreover, device 150 can be accessible as a virtual device by a virtio-net protocol, or other protocols.

Hypervisor 202 can attach a VF or ADI as a virtual device to virtual machine (VM) instance to permit the VM to access device 150 as a VF or ADI. In this example, hypervisor 102 attaches VM1 and VM2 to respective VF1 and VF2. While examples are described with respect to VMs, other processes can be attached to VFs including microservices, containers, or other distributed or virtualized execution environments.

For different virtual machines, input output (IO) workloads can experience different input output (IO) latencies. For example, in a virtio-net driver for device 250, an interrupt handling thread can execute a memory mapped IO (MMIO) write instruction followed by a serialization instruction (e.g., LOCK #) to enforce ordering of memory operations for ensuring reliable communication between the driver and device 250. MMIO allows access to hardware device registers and memory using memory read/write instructions, rather than special input/output (I/O) instructions.

If the MMIO write request is mapped to a physically distant caching and home agent (CHA), then the distance traveled via a signal path can increase a time to complete the request. The CHA coordinates the transfer of data and ensures that caches are coherent (e.g., store the same data). When a processor requests data, the CHA first checks its local cache and if the data is not in the cache (a cache miss), the CHA acts as the home agent (HA) for that memory address, contacting other agents and the home directory to access the data. The HA attempts to provide data coherency among cache devices of one or more processes, and one or more memory devices. The HA is responsible for tracking state changes to one or more cache lines.

A virtual function can be mapped to a BAR space address associated with a particular CHA circuitry on a particular computer die. As described herein, hypervisor 202 can assign one or more virtual functions to a group based at least on MMIO write latency of the virtual functions. MMIO write latency for a virtual function can be determined in various manners. A latency of a virtual function can be based on a signal path distance and/or device hops (e.g., compute die hops, IO die hops, or other device hops) between a CHA mapped to an MMIO write request for the virtual function and an input output (IO) die. In other words, a latency of a virtual function can be based on a signal path distance and/or hops between core to CHA and to IO die coupled to a device accessible by the virtual function, the MMIO write originating from the core, being sent to the CHA, and then to VF attached to an IO DIE. Another manner to determine latency can be based on a number of compute dies between a compute die that executes a process and a compute die that includes the CHA. For example, a lowest latency can be associated with a CHA that is positioned on a same compute die as a processor that executes a process whereas a highest latency can be associated with a CHA that is positioned on a compute die whereby a most number of compute die are to be traversed from the processor that executes a process to the CHA. Other manners of determining latency can be utilized.

In some examples, to reduce a latency of MMIO write request to a CHA, hypervisor 202 can adjust a calculation that assigns a VF to a CHA to reduce IO signal path distance and/or number of hops of an MMIO write request to the CHA.

For example, hypervisor 202 can determine MMIO write latency for a VF to a compute die based on a length of a signal path from a core on the compute die through an IO to an associated CHA. For example, hypervisor 202 can execute MMIO write latency test routine with a serialization sematic (e.g., LOCK#) and determine a VF's MMIO write latency. For example, for VF1 to VF12, hypervisor 202 can determine a latency levels based on a communication latency between a CHA mapped to the VF and an IO die. For example, VF2, VF5, VF7, and VF12 can be mapped to CHA(s) that have a similar distance to input output (IO) die(s) connected to device 250. Accordingly, hypervisor 202 can map VF2, VF5, VF7, and VF12 to VF group 0, which corresponds to a low latency group. For example, VF0, VF8, VF10, and VF11 can be mapped to CHA(s) that have a similar distance to input output (IO) die(s) connected to device 250. Accordingly, hypervisor 202 can map VF0, VF8, VF10, and VF11 to VF group 1, which corresponds to a medium latency group. For example, VF1, VF4, and VF12 can be mapped to CHA(s) that have a similar distance to input output (IO) die(s) connected to device 250. Accordingly, hypervisor 202 can map VF1, VF4, and VF12 to VF group 2, which corresponds to a high latency group. In this example, group 0 exhibits the lowest latency, group 1 exhibits the second lowest latency, and group 2 exhibits the highest latency.

In some examples, a MMIO write test tool utilized by a process, operating system (OS), driver, hypervisor, or others can collect data to build VF groups (e.g., VF groups 0 to 2) by sorting latency values for VFs from smallest to largest and then allocating VFs into a group with a range of latency or weight value, and assigning a VF to a group_id associated with the VF group. A VF group can be associated with a range of latency or weight value, such as latency 0 (shortest IO distance/lowest latency range), latency 1 (middle IO distance/medium latency range), and latency 2 (longest IO distance/longest latency range). In some examples, the group_id of a VF group can be set to the latency or weight value.

When cloud service provider (CSP) hypervisor 202 deploys a process (e.g., VM) on a certain computer die (e.g., compute die 200-1), hypervisor 202 can select a VF to attach to the process based on latency level associated with the VF and a priority of the process. For example, VF selection can be based on:

0≤|Weight−C_DIE_ID|+Weight≤2
where,
   weight is the VF affinity weight in a group whereby highest priority processes have weight value of 0 and lowest priority process has a weight value of 2 and
   C_DIE_ID is the computer DIE ID for the process that executes on a core.

For example, in a CPU package with 3 compute die, traversals of 2 compute dies to device 250 can represent a further signal traversal and can be configured as too long a signal traversal and latency. In such case, where hypervisor 202 causes execution of a process on compute die 200-0 (C_DIE_ID=0), hypervisor 202 can select a VF as follows:

0≤|0−1|+0=2 //weight=0

0≤|1−1|+1=2 //weight =1
0≤|2−1|+2=3 // weight=2. Not selected because the latency is too high.

Other manners of selecting a VF for attachment to a process can be performed.

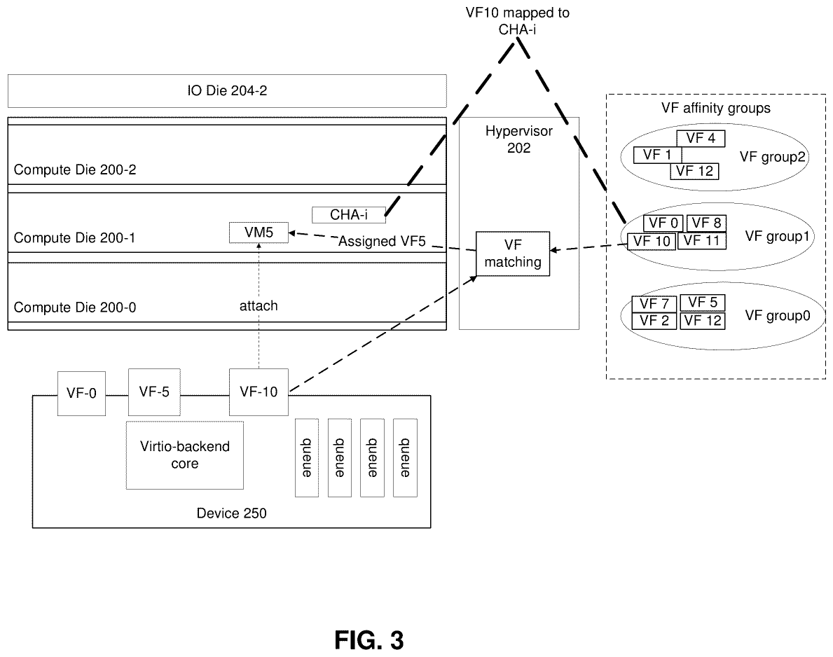

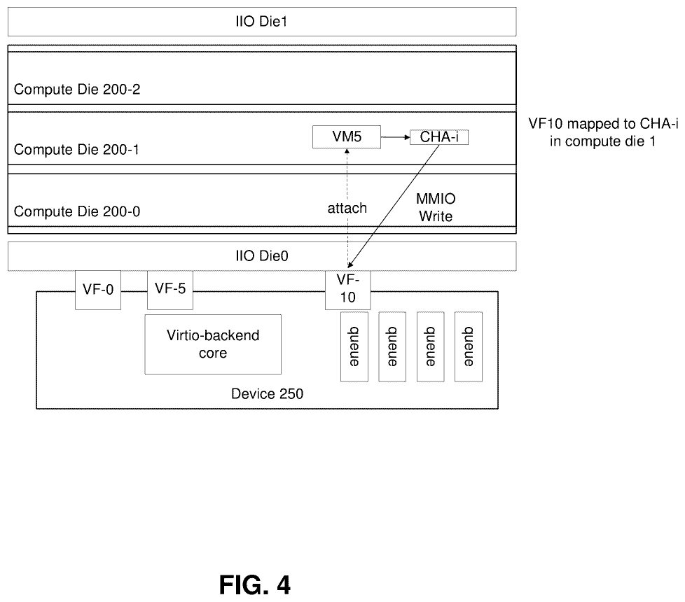

FIG. 3 shows an example of assignment of a virtual function to a process. For example, hypervisor 202 can select an available VF for VM5 based on latency level permitted for VM5 for accessing device 250, specified in a service level agreement (SLA). For example, hypervisor 202 can select VF-10 whose weight is 1, from group 1, that meets a latency level permitted for VM5. Hypervisor 202 can attach VF-10 to VM5 and VM5 can access device 250 using VF-10 in accordance with SR-IOV, or other device virtualization technologies. FIG. 4 shows an example MMIO path of VF-10 to CHA-i on compute die 200-1. An MMIO write originates from a core on compute die 200-1 that executes VM5, travels to CHA-i (also on die 200-1), and then to VF-10 in the PCIe device.

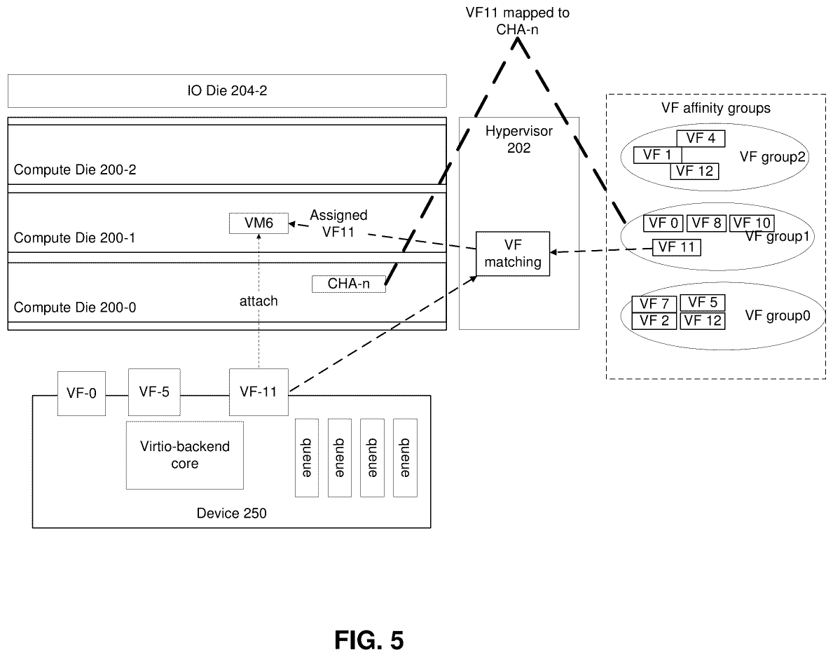

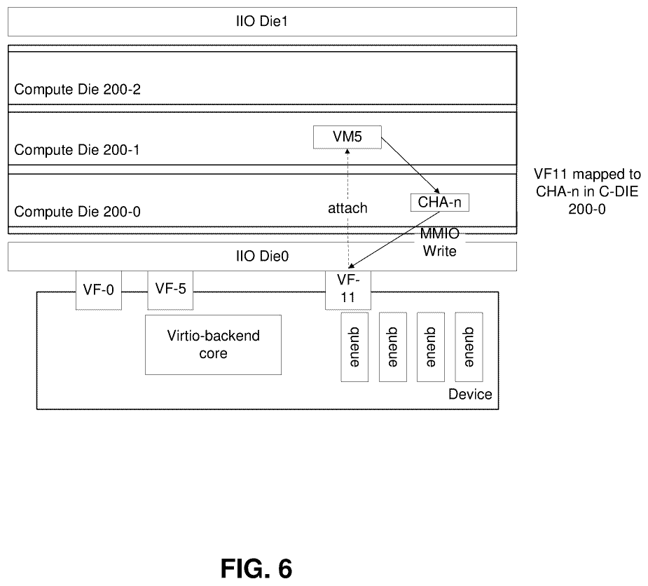

FIG. 5 shows an example of assignment of a virtual function to a process. For example, hypervisor 202 can select an available VF for VM6 based on latency level permitted for VM6, specified in an SLA associated with VM6. For example, hypervisor 202 can select VF-11 whose weight is 1, from group 1, that meets a latency level permitted for VM 6. Hypervisor 202 can attach VF-11 to VM6 and VM6 can access device 250 using VF-11 in accordance with SR-IOV, or other device virtualization technologies. FIG. 6 shows an example of the MMIO path of VF-11 to CHA-n on compute die 1. An MMIO write originates from a core on compute die 200-1 that executes VM5, travels to CHA-n (on die 200-1), for a one compute die hop, and then to VF-11 in the PCIe device.

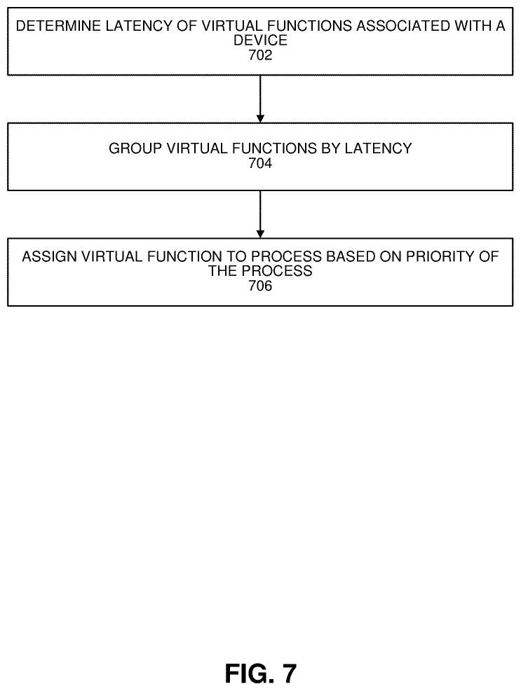

FIG. 7 depicts an example process. The process can be performed by a hypervisor in some examples. At 702, a determination can be made as to latency of write operations for virtual functions associated with a device. The latency of write operations for virtual functions in a system can be based on a signal path distance between a CHA mapped to an MMIO write request for the virtual function and an input output (IO) die.

At 704, latency of write operations for virtual functions can be ranked and virtual functions can be grouped based on ranges of latency of write operations. For example, a first group can represent virtual functions with a lowest range of latency of write operations. For example, a second group can represent virtual functions with a second lowest range of latency of write operations. For example, a last group can represent virtual functions with a highest range of latency of write operations and can provide slowest read or write access to a device associated with a device.

At 706, a virtual function can be assigned to a process based on a priority of the process and latency of the virtual function. For example, a high priority process can be assigned a lowest latency virtual function to provide fastest available access to the device. For example, a low priority process can be assigned a highest latency virtual function to provide slowest available access to the device.

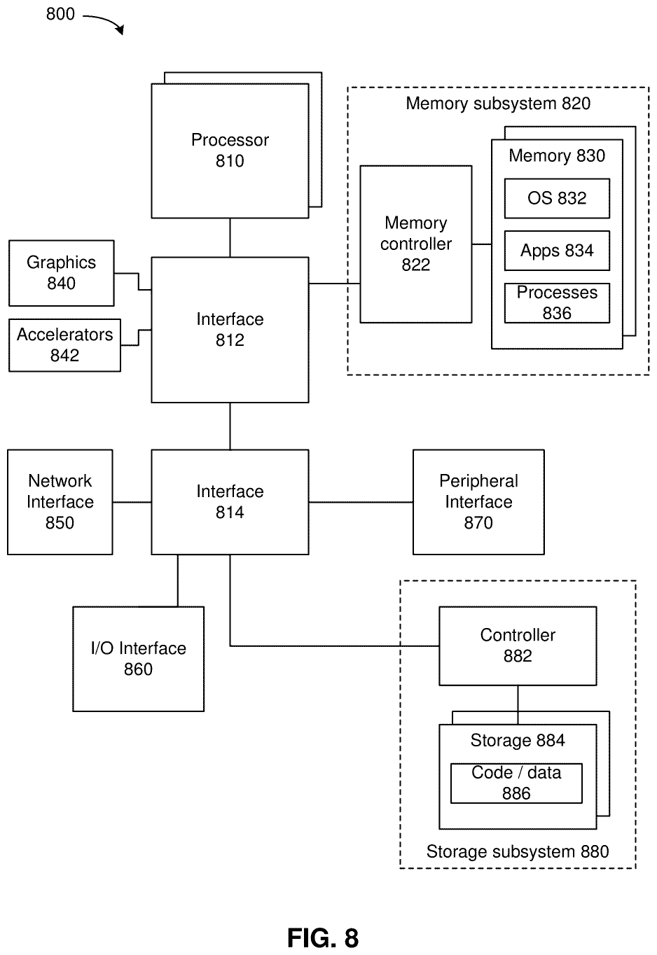

FIG. 8 depicts a system. In some examples, circuitry of system 800 can be accessed by virtual functions assigned to processes based on priority of the process and latency of the virtual function, as described herein. System 800 includes processor 810, which provides processing, operation management, and execution of instructions for system 800. Processor 810 can include any type of microprocessor, core, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Graphics interface 840 can provide an interface to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium, comprising instructions stored thereon, that if executed by one or more processors, cause the one or more processors to: assign a virtual function (VF) to a processor based at least, in part, on a latency of a memory write operation, wherein the virtual function is to provide a process with access to a device and wherein the processor is to execute the process.

Example 2 includes one or more prior or later examples, wherein the latency is associated with a VF memory address mapped to a cache and home agent (CHA).

Example 3 includes one or more prior or later examples, wherein the latency is associated with a number of compute die traversals by the write operation.

Example 4 includes one or more prior or later examples, and includes instructions stored thereon, that if executed by one or more processors, cause the one or more processors to: determine latency associated with multiple VFs, wherein the multiple VFs comprise the VF; associate one or more VFs of the multiple VFs with a group; and assign the process to the VF by assigning the process to a particular group.

Example 5 includes one or more prior or later examples, wherein the device comprises one or more of: an accelerator, network interface device, graphics processor, or memory device.

Example 6 includes one or more prior or later examples, and includes instructions stored thereon, that if executed by one or more processors, cause the one or more processors to: adjust a cache and home agent (CHA) associated with a second virtual function to reduce a write latency of a second write operation associated with the second virtual function to the CHA.

Example 7 includes one or more prior or later examples, and includes a method that includes: assigning a virtual function (VF) to a processor based at least, in part, on a latency of a memory write operation, wherein the virtual function is to provide a process with access to a device and wherein the processor is to execute the process.

Example 8 includes one or more prior or later examples, wherein the latency is associated with a VF memory address mapped to a cache or home agent.

Example 9 includes one or more prior or later examples, wherein the latency is associated with a number of compute die traversals by the write operation.

Example 10 includes one or more prior or later examples, and includes determining latency associated with multiple VFs, wherein the multiple VFs comprise the VF; associating one or more VFs of the multiple VFs with a group; and assigning the process to the VF by assigning the process to a particular group.

Example 11 includes one or more prior or later examples, wherein the device comprises one or more of: an accelerator, network interface device, graphics processor, or memory device.

Example 12 includes one or more prior or later examples, and includes adjusting a cache and home agent (CHA) associated with a second virtual function to reduce a write latency of a second write operation to the CHA.

Example 13 includes one or more prior or later examples, and includes an apparatus that includes: a processor to execute a process and an interface to a device, wherein: a virtual function (VF) is assigned to the process based at least, in part, on a latency of a memory write operation, wherein the virtual function is to provide the process with access to the device.

Example 14 includes one or more prior or later examples, wherein the latency is associated with a VF address mapped to a cache or home agent.

Example 15 includes one or more prior or later examples, wherein the latency is associated with a number of hops between the processor to a caching and home agent (CHA) and to an input output (IO) die coupled to the device accessible by the virtual function.

Example 16 includes one or more prior or later examples, wherein the VF is assigned to the process based at least in part on: latency associated with multiple VFs, wherein the multiple VFs comprise the VF; association of one or more VFs of the multiple VFs with a group; and assignment of the VF to the process by assigning the process to a particular group.

Example 17 includes one or more prior or later examples, wherein the device comprises one or more of: an accelerator, network interface device, graphics processor, or memory device.

Example 18 includes one or more prior or later examples, and includes circuitry to: change a cache and home agent (CHA) associated with a second virtual function to reduce a write latency of a second write operation to the CHA.

1. At least one non-transitory computer-readable medium, comprising instructions stored thereon, that if executed by one or more processors, cause the one or more processors to:
assign a virtual function (VF) to a processor based at least, in part, on a latency of a memory write operation, wherein the virtual function is to provide a process with access to a device and wherein the processor is to execute the process.

2. The non-transitory computer-readable medium of claim 1, wherein the latency is associated with a VF memory address mapped to a cache and home agent (CHA).

3. The non-transitory computer-readable medium of claim 1, wherein the latency is associated with a number of compute die traversals by the write operation.

4. The non-transitory computer-readable medium of claim 1, comprising instructions stored thereon, that if executed by one or more processors, cause the one or more processors to:
determine latency associated with multiple VFs, wherein the multiple VFs comprise the VF;
associate one or more VFs of the multiple VFs with a group; and
assign the process to the VF by assigning the process to a particular group.

5. The non-transitory computer-readable medium of claim 1, wherein the device comprises one or more of: an accelerator, network interface device, graphics processor, or memory device.

6. The non-transitory computer-readable medium of claim 1, comprising instructions stored thereon, that if executed by one or more processors, cause the one or more processors to:
adjust a cache and home agent (CHA) associated with a second virtual function to reduce a write latency of a second write operation associated with the second virtual function to the CHA.

7. A method comprising:
assigning a virtual function (VF) to a processor based at least, in part, on a latency of a memory write operation, wherein the virtual function is to provide a process with access to a device and wherein the processor is to execute the process.

8. The method of claim 7, wherein the latency is associated with a VF memory address mapped to a cache or home agent.

9. The method of claim 7, wherein the latency is associated with a number of compute die traversals by the write operation.

10. The method of claim 7, comprising:
determining latency associated with multiple VFs, wherein the multiple VFs comprise the VF;
associating one or more VFs of the multiple VFs with a group; and
assigning the process to the VF by assigning the process to a particular group.

11. The method of claim 7, wherein the device comprises one or more of: an accelerator, network interface device, graphics processor, or memory device.

12. The method of claim 7, comprising:
adjusting a cache and home agent (CHA) associated with a second virtual function to reduce a write latency of a second write operation to the CHA.

13. An apparatus comprising:
a processor to execute a process and
an interface to a device, wherein:
a virtual function (VF) is assigned to the process based at least, in part, on a latency of a memory write operation, wherein the virtual function is to provide the process with access to the device.

14. The apparatus of claim 13, wherein the latency is associated with a VF address mapped to a cache or home agent.

15. The apparatus of claim 13, wherein the latency is associated with a number of device hops between the processor to a caching and home agent (CHA) and to an input output (IO) die coupled to the device accessible by the virtual function.

16. The apparatus of claim 13, wherein the VF is assigned to the process based at least in part on:
latency associated with multiple VFs, wherein the multiple VFs comprise the VF;
association of one or more VFs of the multiple VFs with a group; and
assignment of the VF to the process by assigning the process to a particular group.

17. The apparatus of claim 13, wherein the device comprises one or more of: an accelerator, network interface device, graphics processor, or memory device.

18. The apparatus of claim 13, comprising:
circuitry to:
change a cache and home agent (CHA) associated with a second virtual function to reduce a write latency of a second write operation to the CHA.
